(19) United States
(12) Patent Application Publication
(10) Pub. No.: US 2011/0231874 A1
(43) Pub. Date: Sep. 22, 2011

(54) Smart Address Book

(75) Inventors: Brandon Hall Goode, Canton, GA (US); Brett Brock, Roswell, GA (US); Robert C. Whitten, Kennesaw, GA (US)

(73) Assignee: Cox Communications, Inc., Atlanta, GA (US)

(21) Appl. No.: 12/728,626

(22) Filed: Mar. 22, 2010

(51) Int. Cl. G06F 3/048; G06F 15/16; H04N 5/445

(52) U.S. Cl. 725/37; 715/764; 709/203; 709/206

(57) ABSTRACT

A database of a user's contacts and associated contact addresses and real-time presence data may be received and stored in a network-based smart address book. A smart address book application may receive and store one or more contact names, one or more contact addresses for each contact name, and presence data for each contact address. Contact and presence information stored in a smart address book may be transmitted via a network to an endpoint computing device and displayed thereon.

### BACKGROUND

With the increase of newer communications technologies, there are numerous modes of communication available. Many people have multiple phone numbers, email addresses, and other contact points at which they may be contacted. Many communication devices include an address book in which a user may store his/her contacts and contact information associated with those contacts. Most current address book systems are static in nature and are deficient in providing real-time information. In a case where a user has multiple communication devices, each communication device may have its own address book. Such separate address books typically require a user to enter the same information in multiple address book databases. A user may synchronize an address book on one device with another address book on another device. However, information may only be updated upon synchronization, not in real-time. Separate address books may be difficult to maintain because of changes to recipient information. Another deficiency in a typical address book system is that presence information may not be provided for a user's contacts. A user may have several points of contact (e.g., mobile phone number, e-mail address, home phone number, etc.) for a given contact, but may not know which method of communication may be the best way to reach the contact at a given time.

### SUMMARY

Consistent with embodiments of the present invention, systems and methods are disclosed for providing a network-based presence tracking smart address book. Contact information may be stored in a user's smart address book. Because a smart address book is network-based, a single smart address book may be utilized for various communication devices that a user may utilize. A user may utilize various communication mechanisms (e.g., e-mail, instant messaging, voice, etc.) on various communication devices (e.g., personal computer, home phone, mobile phone, personal digital assistant (PDA), set-top box (STB), etc.). Each device may communicate with a network-based smart address book so that a user's contact information may be consistent among his/her various communication devices.

In addition to contact information associated with a contact, embodiments of the present invention may also include real-time presence information with respect to a contact's availability (i.e., presence state). Presence information may convey a contact's ability and/or willingness to communicate on one or more communication devices. For example, a user may have contact information for a contact's mobile phone and home computer. If the contact's mobile phone is turned off and he/she has been using his/her home computer, the presence information may reveal to the user that the specified contact is unavailable for communication via his/her mobile phone, but may be available for communication at his/her home computer, and thus may be contacted via e-mail or instant messaging (IM).

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

FIG. 1 is a block diagram of a distributed communications network 100;

FIG. 2 is a flow diagram of a method 200 for providing real-time contact and presence data;

FIG. 3 is a block diagram of a cable television/services (CATV) system 300.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Communication media including electronic media, telecommunications media, and broadcast media were once distinct and separate services. Recently, service providers are offering a convergence of services. A user may utilize a plurality of services on a single device. For example, a cable television services set-top box (STB) 150 may be utilized for not only television services, but may also be utilized for telephony, Internet services, e-mail, music, location-based services, etc. And, in accordance with common Internet Protocols (IP), such devices may be utilized as a user interface to communicate over a packet-switched network.

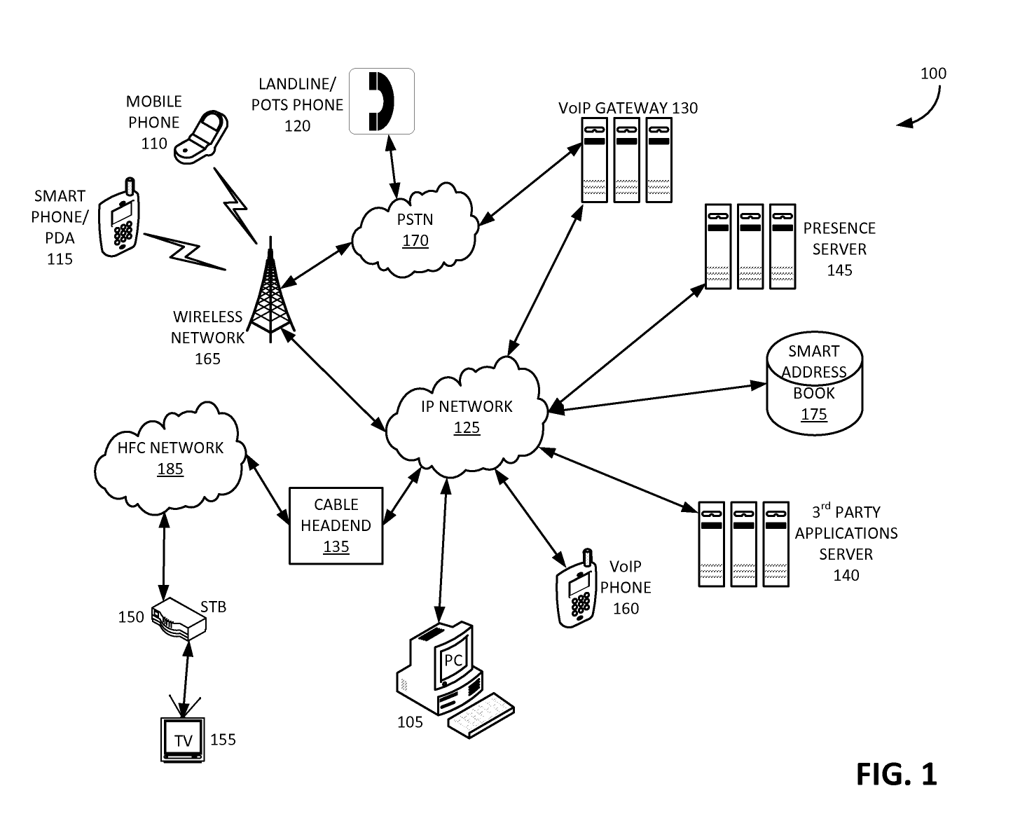

FIG. 1 is a block diagram illustrating an architecture 100 that provides a network-based presence tracking smart address book via a packet-switched network according to embodiments of the present invention. An IP-based (Internet Protocol) architecture provides for a variety of end-point devices (e.g., personal computers 105, mobile phones 110, personal digital assistants (PDA) 115, digital phones, etc.) to communicate with one or more remote applications or other end-point devices via one or more distributed packet-switched networks (e.g., Internet, WAN) 125.

Wireless communication devices, such as a mobile phone 110, PDA 115, or other mobile computing devices may be connected to a wireless voice and data network 165. A wireless network may connect to a public switched telephone network (PSTN) 170 and/or may connect to a packet-switched network (Internet) 125 via a wireless network gateway. Plain old telephone system (POTS) and landline telephones 120 may connect to a wireless network 165 via a public switched telephone network (PSTN) 170. A VoIP network gateway 130 may serve as a translator between the PSTN 170 and IP networks 125. Dedicated VoIP phones 160 allow VoIP calls without the use of a computer 105. A VoIP phone 160 may connect directly to an IP network 125 to communicate with other endpoints. Personal computers 105 may connect to an IP network 125 for various communications, such as voice, e-mail, messaging, faxing, etc. As should be appreciated, transmission technologies for delivery of voice and/or data communications over IP networks such as the Internet or other packet-switched networks is a known technology to those skilled in the art and will not be discussed in extensive detail herein.

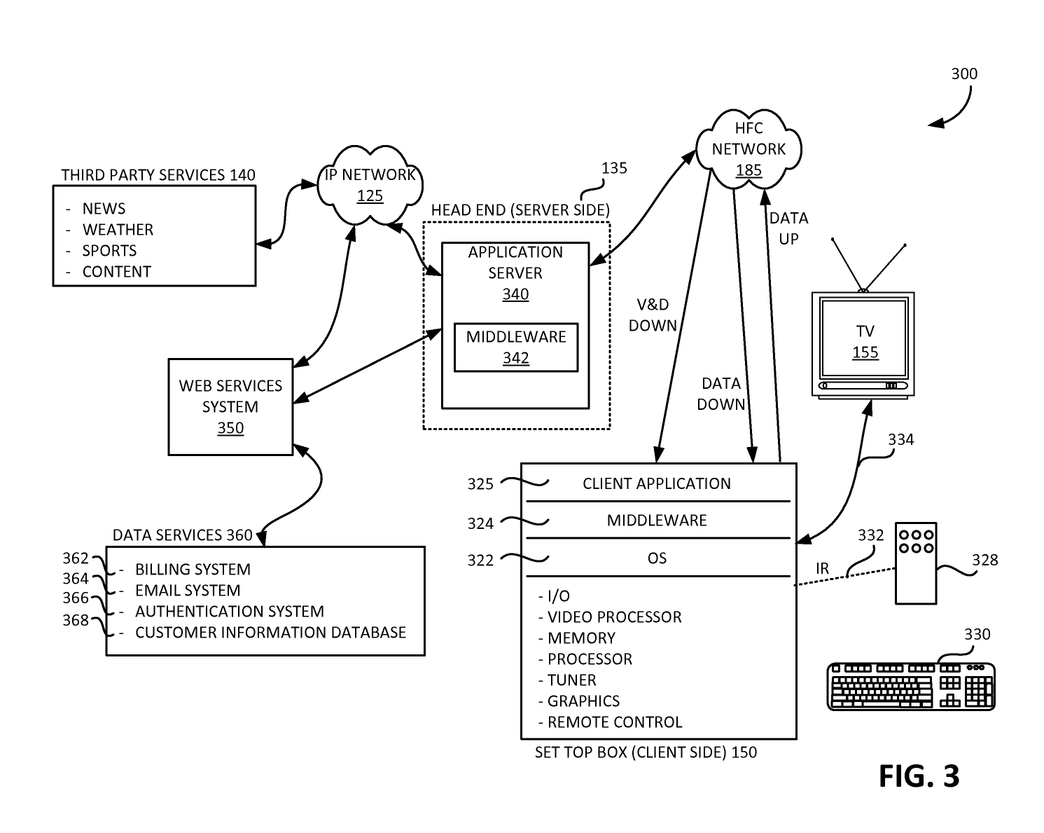

Recently, cable set-top boxes (STB) 150 have become more than a device in which to receive digital television, but may be used to provide a variety of services, including but not limited to telephone services, high-speed Internet access, Video on Demand (VOD), and information services. A simplified block diagram illustrating a cable television/services system (hereafter referred to as “CATV”) architecture that serves as an exemplary operating environment for the present invention will be described in further detail later in this document with reference to FIG. 3.

According to an embodiment of the present invention, a presence server 145 may be connected to an IP network 100 and may be utilized to receive current presence and availability data of a contact. A contact's presence information may be shared with others who may wish to know the availability or willingness of the contact to communicate. A contact's presence information may also be received by a system, wherein a decision may be made as to when, how, or whether to contact one or more communication devices (e.g., computer 105, mobile phone 110, etc.) An entity that may be associated with, defined by and/or described by presence data may be referred to as a “presentity.” The term “presentity” will be used herein for convenience and may also be used to describe a contact whose presence information is monitored and/or requested by a user or by a system. By revealing more information about a contact, such as a location, status, current activity, or even a person's mood, communication may be enhanced. Multiple communication devices associated with a presentity may be tracked by a presence server 145. A presence server 145 may track the presence of a presentity's computer 105, mobile phone 110, PDA 115, landline/POTS phone 120, STB 150, etc.

According to one embodiment, presence information may be automatically updated to a presence server 145 every time a presentity's presence status changes. For example, if a presentity utilizes his/her mobile phone 110 to make a phone call, a presence server 145 may detect a change in the his/her presence status and may store the contact's presence data in a smart address book database 175. According to another embodiment, a presentity's presence information may be manually entered by the presentity. For example, a presentity may go on vacation and may wish not to be contacted. He/she may manually set his/her presence data as busy or unavailable on all communication devices. According to another embodiment, a presentity's electronic calendar may provide presence data that may be tracked by a presence server 145. For example, a presentity may have a meeting scheduled in his/her electronic calendar. A presence server 145 may detect the scheduled meeting and consider the presentity's presence state as busy. In one embodiment, a presence server 145 and a smart address book database 175 may be located remotely. Alternatively, a smart address book database 175 may be located on a presence server 145.

A smart address book 175 is operative to store a list of one or more contacts including contact information, presence data, and any other data that may be associated with a contact, and be accessed by one or more end point devices 105,110,115,120,150,160 across a network 125. According to an embodiment, a smart address book 175 contains Extensible Markup Language (XML) data structures which may define contact information. As should be understood, XML is only one example data structure type or method and is not limiting of other data structure languages or types that may be utilized. Endpoint devices may utilize a standard session initiated protocol (SIP) format to communicate presence and contact information across a network 125. A smart address book 175 may store a user's contact list, which may contain one or more telephone numbers, e-mail addresses, IP addresses, and availability data associated with each contact number/address.

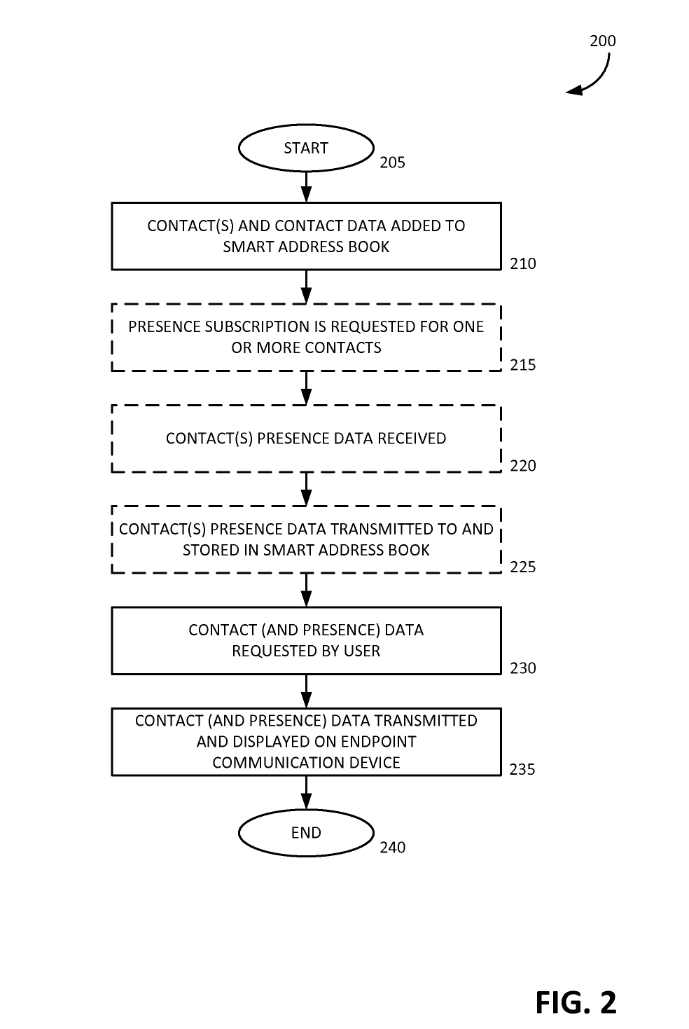

Having described elements of an architecture 100 that provides a network-based presence tracking smart address book, FIG. 2 is a flow diagram of an exemplary method 200 for providing real-time contact and presence data. The method 200 starts at OPERATION 205 and proceeds to OPERATION 210 where a user generates a database for storing one or more contacts and contact data (e.g., addresses, telephone numbers, e-mail addresses, fax numbers, IP addresses, etc.) associated with each contact. According to an embodiment, a user's contacts data may be stored in a smart address book database 175 located remotely, which may be accessed via a distributed network 125. Contents of a user's smart address book 175 may be generated from one or more address books that a user may utilize. Various communication devices 105,110,115,120,150,160 may access a smart address book 175, wherein a user may view an up-to-date unified list of all his/her contacts. A user may add contacts and contact data to a smart address book 175 by various means, such as manually entering contact information, synchronizing with other electronic address books, automatically adding a contact and associated contact information when a call is placed or a message is sent, as well as by other ways known in the art.

A user may wish to receive presence data associated with a contact in his/her address book. A contact may wish to share his/her presence information to convey his/her ability or willingness to communicate at a given time. In OPERATION 215, a user may subscribe to request presence information for one or more contacts. According to an embodiment, a request may be sent to a presence server 145 to request subscription to a presentity's presence information. A presence server 145 may detect a presentity's presence on various communication devices (e.g., instant messenger (IM) client, home phone, mobile phone, VoIP phone, computer, PDA, electronic calendar, etc.). A presentity's presence data may include system-generated status and/or user-set status. For example, “online,” “idle,” and a presentity's location are examples of system-generated status. “Busy,” “invisible,” or a presentity's mood are examples of user-set status. Since its introduction, presence data has become more accurate and more specific. A variety of rich presence information may be detected and shared, such as multiple devices for a presentity, activities (current and planned), surroundings (noise, privacy, in a vehicle, etc.), if a presentity is composing (typing, recording audio/video, IM, etc), etc.

At OPERATION 220, a presentity's presence data may be received by a presence server 145. According to an embodiment, whenever a presentity engages/disengages in communication or other activity which may be detected by a presence server 145, his/her presence information may be updated to reflect his/her presence status. For example, if a presentity is on the phone, his/her presence information may be updated to reflect that he/she is busy or that he/she may not be able/willing to receive another call to the phone that he/she is using. A presentity's electronic calendar may also be utilized to provide presence data to a presence server 145. For example, if a presentity has a scheduled meeting on his/her electronic calendar, a presence server 145 may update his/her presence status as “busy” or “in a meeting.” Alternatively, if a presentity is in a situation in which he/she may not receive voice calls, but may be able available to IM, his/her presence information may reflect that. In some cases, a presentity may utilize a “dumb” communication device, such as a POTS phone 120. A gateway 130 may be utilized to facilitate communications between a POTS phone 120 connected to a PSTN network 170. An IP gateway 130 may convert analog signals into an IP format, which a presence server 145 may utilize to determine presence information.

According to an embodiment, a presence server 145 may receive presence information from a CATV network 300. CATV-related presence information may be provided by a STB 150, which may be collected and sent to a presence server 145 and stored in a smart address book 175. A user may obtain a presentity's presence information and see that he/she is watching TV, or even that he/she is watching a certain channel. According to an embodiment, presence information relative to a STB 150 may be utilized as a parental control mechanism. For example, a user may have a STB 150 monitored in his/her smart address book 175 (e.g., a parent monitoring his/her home STB). He/she may receive an update from a presence server 145 that a certain channel, whose programming may not be deemed suitable by the user, is being watched (e.g., by a child). As should be appreciated, there may be numerous applications for utilizing a STB 150 for providing presence data.

At OPERATION 225, presence data is transmitted and stored in a smart address book 175. A smart address book 175 may be located remotely and accessed via a distributed network 125, or may be located on a presence server 145.

At OPERATION 230, a user may make a request to view contact information for a given contact stored in his/her address book 175. At OPERATION 235, one or more contacts from a user's smart address book 175 and their corresponding contact and presence data may be transmitted and displayed on one or more devices capable of displaying contact data as requested by the user. The method ends at OPERATION 240.

As described herein, embodiments of the present invention may operate in association with components of a cable television services system, such as a cable system set-top box. With reference to FIG. 3, a cable television/services system (hereafter referred to as “CATV”) architecture 300 that serves as an exemplary operating environment for embodiments of the invention is described. Referring now to FIG. 3, digital and analog video programming, information content and interactive television services are provided via a hybrid fiber coax (HFC) network 185 to a television set 155 for consumption by a cable television/services system customer. As is known to those skilled in the art, HFC networks 185 combine both optical fiber and coaxial cable lines. Typically, optical fiber runs from the cable head end 135 to neighborhoods of 500 to 2,000 customers. Coaxial cable runs from the optical fiber feeders to each customer. According to embodiments of the present invention, the functionality of the HFC network 185 allows for efficient bidirectional data flow between the client-side set-top box 150 and the server-side application server 340 of the present invention.

According to embodiments of the present invention, the CATV system 300 is in the form of a distributed client-server computing system for providing video and data flow across the HFC network 185 between server-side services providers (e.g., cable television/services providers) via a server-side (backend) head end 135 and a client-side customer via a client-side set-top box (STB) functionally connected to a customer receiving device, such as the television set 155. As is understood by those skilled in the art, modern CATV systems 300 may provide a variety of services across the HFC network 185 including traditional digital and analog video programming, telephone services, high speed Internet access, video-on-demand, and information services.

On the client side of the CATV system 300, digital and analog video programming and digital and analog data are provided to the customer television set 155 via the set-top box (STB) 150. Interactive television services that allow a customer to input data to the CATV system 300 likewise are provided by the STB 150. As illustrated in FIG. 3, the STB 150 is a multipurpose computing device having a computer processor, memory and an input/output mechanism. The input/output mechanism of a STB 150 receives input from server-side processes via the HFC network 185 and from customers via input devices such as the remote control device 328 and the keyboard 330. The remote control device 328 and the keyboard 330 may communicate with the STB 150 via a suitable communication transport such as the infrared connection 332. The STB 150 also includes a video processor for processing and providing digital and analog video signaling to the television set 155 via a cable communication transport 334. A multi-channel tuner is provided for processing video and data to and from the STB 150 and the server-side head end system 135, described below.

The STB 150 also includes an operating system 322 for directing the functions of the STB 150 in conjunction with a variety of client applications 325. For example, if a client application 325 requires a news flash from a third-party news source to be displayed on the television 155, the operating system 322 may cause the graphics functionality and video processor of the STB 150, for example, to output the news flash to the television 155 at the direction of the client application 325 responsible for displaying news items.

Because a variety of different operating systems 322 may be utilized by a variety of different brands and types of set-top boxes, a middleware layer 324 is provided to allow a given software application to be executed by a variety of different operating systems. According to an embodiment of the present invention, the middleware layer 324 may include a set of application programming interfaces (API) that are exposed to client applications 325 and operating systems 322 that allow the client applications to communicate with the operating systems through common data calls understood via the API set. As described below, a corresponding middleware layer is included on the server side of the CATV system 300 for facilitating communication between the server-side application server and the client-side STB 150. According to one embodiment of the present invention, the middleware layer 342 of the server-side application server and the middleware layer 324 of the client-side STB 150 format data passed between the client side and server side according to the Extensible Markup Language (XML). As should be appreciated by those skilled in the art, although some embodiments described in this specification are oriented to middleware installed and executed on a STB 150, alternative embodiments implemented as firmware or as hardware are well within the scope of the present invention. As should be appreciated, XML is only one example of data formatting, data passed between the client side and the server side may be formatted according to any other suitable formatting language or standard.

The set-top box 150 passes digital and analog video and data signaling to the television 155 via a one-way communication transport 334. According to another embodiment, bidirectional communication may be accomplished between the STB 105 and the television 120. For example, high-definition multimedia interface (HDMI) ports on the STB 105 and television 120 allow for bidirectional data communications between the devices. The STB 150 may receive video and data from the server side of the CATV system 300 via the HFC network 185 through a video/data downlink and data via a data downlink. The STB 150 may transmit data from the client side of the CATV system 300 to the server side of the CATV system 300 via the HFC network 185 via one data uplink. The video/data downlink is an “in band” downlink that allows for digital and analog video and data signaling from the server side of the CATV system 300 through the HFC network 185 to the set-top box 150 for use by the STB 150 and for distribution to the television set 155. As should be appreciated, functionality of a STB may reside in a stand-alone device, or alternatively, be performed by hardware resident elsewhere, such as within a television or by a suitably equipped terminal device. The “in band” signaling space may operate at a variety of frequencies. According to one embodiment, the “in band” signaling space may operate at a frequency between 54 and 1000 megahertz. The signaling space is generally divided into 6 megahertz channels in which may be transmitted a single analog signal or a greater number (e.g., up to ten) digital signals.

The data downlink and the data uplink, illustrated in FIG. 3, between the HFC network 185 and the set-top box 150 comprise “out of band” data links. As is understand by those skilled in the art, the “out of band” frequency range generally lies between zero and 54 megahertz. According to embodiments of the present invention, data flow between the client-side set-top box 150 and the server-side application server 340 is typically passed through the “out of band” data links. Alternatively, an “in band” data carousel may be positioned in an “in band” channel into which a data feed may be processed from the server-side application server 340 through the HFC network 185 to the client-side STB 150. Operation of data transport between components of the CATV system 300, described with reference to FIG. 3, is well known to those skilled in the art.

Referring still to FIG. 3, the head end 135 of the CATV system 300 is positioned on the server side of the CATV system and includes hardware and software systems responsible for originating and managing content for distributing through the HFC network 185 to client-side STBs 150 for presentation to customers via televisions 155. As described above, a number of services may be provided by the CATV system 300, including digital and analog video programming, interactive television services, telephone services, video-on-demand services, targeted advertising, and provision of information content.

The application server 340 is a general-purpose computing system operative to assemble and manage data sent to and received from the client-side set-top box 150 via the HFC network 185. As described above with reference to the set-top box 150, the application server 340 includes a middleware layer 342 for processing and preparing data from the head end of the CATV system 300 for receipt and use by the client-side set-top box 150. For example, the application server 340 via the middleware layer 342 may obtain data from third-party services 140 via the Internet 125 for transmitting to a customer through the HFC network 185 and the set-top box 150. For example, a weather report from a third-party weather service may be downloaded by the application server via the Internet 125. When the application server 340 receives the downloaded weather report, the middleware layer 342 may be utilized to format the weather report for receipt and use by the set-top box 150. According to one embodiment of the present invention, data obtained and managed by the middleware layer 342 of the application server 340 is formatted according to the Extensible Markup Language and is passed to the set-top box 150 through the HFC network 185 where the XML-formatted data may be utilized by a client application 325 in concert with the middleware layer 324, as described above. As should be appreciated by those skilled in the art, a variety of third-party services data, including news data, weather data, sports data and other information content, may be obtained by the application server 340 via distributed computing environments such as the Internet 125 for provision to customers via the HFC network 185 and the set-top box 150. According to an embodiment of the present invention, digital video recording functionality may be located remotely on the head end (server side) 135 and called upon by a client set-top box 150.

According to embodiments of the present invention, the application server 340 obtains customer profile data from services provider data services 360 for preparing a customer profile that may be utilized by the set-top box 150 for tailoring certain content provided to the customer and for pre-populating product/services order forms and customer lead generation forms. As illustrated in FIG. 3, the services provider data services 360 include a number of services operated by the services provider of the CATV system 300 which may include data on a given customer. For example, a billing system 362 may include information such as a customer's name, street address, business identification number, Social Security number, credit history, and information regarding services and products subscribed to by the customer. An electronic mail system 364 may contain information such as electronic mail addresses, high-speed Internet access subscription information and electronic mail usage data. An authentication system 366 may include information such as secure user names and passwords utilized by customers for access to network services.

The customer information database 368 may include general information about customers such as place of employment, business address, business telephone number and demographic information such as age, gender, educational level, and the like. The customer information database may also include information on products and services subscribed to by a customer from her cable services provider. For example, in accordance with embodiments of the present invention, the customer information database may contain data to allow a determination as to whether a particular product or service is already provisioned at a customer service address or whether a work order is pending for a particular product or service provisioning at the customer service address. The customer information database may also include information that allows for a determination as to whether prerequisites for provisioning a requested product of service are met by a requesting customer. For example, if a customer requests electronic mail services and high speed Internet access is a prerequisite for electronic mail services, the customer information database may be queried to determine whether the required Internet access is provisioned at the requesting customer location or address.

As should be understood by those skilled in the art, the disparate data services systems 362, 364, 366, 368 are illustrated as a collection of data services for purposes of example only. The example data services systems comprising the data services 360 may operate as separate data services systems, which communicate with a web services system (described below) along a number of different communication paths and according to a number of different communication protocols

Referring still to FIG. 3, a web services system 350 is illustrated between the application server 340 and the data services 360. According to embodiments of the present invention, the web services system 350 serves as a collection point for data requested from each of the disparate data services systems comprising the data services 360. When the application server 340 requires customer profile data from one or more of the data services 360 for preparation or update of a customer profile, the application server 340 passes a data query to the web services system 350. The web services system formulates a data query to each of the available data services systems for obtaining any available data for a given customer as identified by a set-top box identification associated with the customer. The web services system 350 serves as an abstraction layer between the various data services systems and the application server 340. That is, the application server 340 is not required to communicate with the disparate data services systems, nor is the application server 340 required to understand the data structures or data types utilized by the disparate data services systems. The web services system 350 is operative to communicate with each of the disparate data services systems for obtaining necessary customer profile data. The customer profile data obtained by the web services system is assembled and is returned to the application server 340 for ultimate processing via the middleware layer 342, as described above.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, data storage via carrier waves, or other forms of RAM or ROM. Further, the disclosed methods' stages may be modified in any manner, including by reordering stages and/or inserting or deleting stages, without departing from the invention.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing a network-based presence-tracking smart address book, the method comprising:
receiving one or more contact names and one or more contact addresses associated with each one or more contact names;
receiving a request for presence subscription associated with one or more contact names;
in response to receiving a request for presence subscription associated with one or more contact names, receiving presence data from one or more network elements including a cable television/services system set-top box associated with one or more contact names;
storing presence data including cable television/services system related presence data associated with one or more contact names in a network-based smart address book;
receiving a request by a user to view one or more contact names and corresponding contact and presence data; and
transmitting requested contact and presence data to a requesting endpoint communication device.

2. The method of claim 1 wherein a contact address may comprise a landline telephone number, a mobile telephone number, a personal digital assistant number, an e-mail address, a fax number, a Internet Protocol (IP) address, a set-top box (STB) address, a Voice over Internet Protocol (VoIP) phone number, or an Instant Messaging (IM) address.

3. The method of claim 1 wherein presence data may be system-generated.

4. The method of claim 1 wherein presence data may be user-set.

5. The method of claim 1 wherein receiving a request for presence subscription associated with one or more contact names includes receiving a request at a presence server having network-related presence data associated with a one or more presentities associated with the one or more contact names.

6. The method of claim 5 wherein the presence server is connected to an IP network.

7. The method of claim 1 wherein a smart address book stores one or more contact names, contact addresses, and presence data.

8. The method of claim 7 wherein the smart address book is connected to an IP network.

9. The method of claim 1 wherein cable television/services system related presence data associated with one or more contact names may comprise watched programming information.

10. The method of claim 1 wherein cable television/services system related presence data associated with one or more contact names may be utilized as a parental control mechanism.

11. The method of claim 1 wherein a requesting endpoint communication device may comprise a mobile phone, a PDA, a computer, a STB, VoIP phone, or any other device capable of receiving and displaying contact and presence data.

12. A system for providing a network-based presence-tracking smart address book, comprising:
a smart address book application operative to:
receive one or more contact names and one or more contact addresses associated with each one or more contact names;
receive a request for presence subscription associated with one or more contact names;
receive presence data from one or more network elements including a cable television/services system set-top box associated with one or more contact names;
store presence data including cable television/services system related presence data associated with one or more contact names in a network-based smart address book;
receive a request to view one or more contact names and corresponding contact and presence data;
transmit requested contact and presence data to a requesting endpoint communication device.

13. The system of claim 12 wherein a contact address may comprise a landline telephone number, a mobile telephone number, a personal digital assistant number, an e-mail address, a fax number, a Internet Protocol (IP) address, a set-top box (STB) address, a Voice over Internet Protocol (VoIP) phone number, or an Instant Messaging (IM) address.

14. The system of claim 12 wherein a presence server receives network-related presence data associated with a presentity.

15. The system of claim 14 wherein the presence server is connected to an IP network.

16. The system of claim 12 wherein a smart address book stores one or more contact names, contact addresses, and presence data.

17. The system of claim 16 wherein the smart address book is connected to an IP network.

18. The system of claim 16 wherein the smart address book is located remotely from the presence server within an IP network.

19. The system of claim 16 wherein the smart address book is located on the presence server.

20. A computer readable medium having computer executable instructions which when executed by a computer perform a method for providing a network-based presence-tracking smart address book, the method comprising:
receiving one or more contact names and one or more contact addresses associated with each one or more contact names;
receiving a request for presence subscription associated with one or more contact names including receiving a request at a presence server having network-related presence data associated with a one or more presentities associated with the one or more contact names;
in response to receiving a request for presence subscription associated with one or more contact names, receiving presence data from one or more network elements including a cable television/services system set-top box associated with one or more contact names;
storing presence data including cable television/services system related presence data associated with one or more contact names in a network-based smart address book;
receiving a request by a user to view one or more contact names and corresponding contact and presence data; and
transmitting requested contact and presence data to a requesting endpoint communication device.
